(19) United States
(12) Patent Application Publication
(10) Pub. No.: US 2026/0236357 A1
(43) Pub. Date: Aug. 13, 2026

(54) DISTRIBUTED COMPUTER PROCESSING AND INTEGRATED ROBOTICS NETWORKS FOR LUNAR BASES AND SPACE STATIONS

(71) Applicant: Arizona Board of Regents on Behalf of the University of Arizona, Tucson, AZ (US)

(72) Inventors: Jekan THANGAVELAUTHAM, Tucson, AZ (US); Jackson QIU, Tucson, AZ (US); Sivaperuman MUNIYASAMY, Tucson, AZ (US)

(21) Appl. No.: 19/160,064

(22) PCT Filed: Feb. 27, 2024
(86) PCT No.: PCT/US24/17490

§ 371 Date: Aug. 27, 2025

Related U.S. Application Data
(60) Provisional application No. 63/448,734, filed on Feb. 28, 2023.

(51) Int. Cl. G06F 11/20

(52) U.S. Cl. CPC G06F 11/2007

(57) ABSTRACT

In an approach to distributed computer processing networks for lunar bases and space stations, a system includes one or more sensors; a communications network; and a plurality of tiles. The tiles are configured to monitor the one or more sensors via the communications network; track a location of each computing device using the communications network; and responsive to determining any tile of the plurality of tiles has failed, transfer one or more tasks from the tile that has failed to a neighboring tile.

### CROSS-REFERENCE TO RELATED APPLICATIONS

The present application claims the benefit of the filing date of U.S. Provisional Application Ser. No. 63/448,734, filed Feb. 28, 2023, the entire teachings of which application is hereby incorporated herein by reference.

### STATEMENT REGARDING FEDERALLY SPONSORED RESEARCH OR DEVELOPMENT

This invention was made with government support under 80NSSC21M0311 awarded by the National Aeronautics and Space Administration (NASA). The government has certain rights in the invention.

### TECHNICAL FIELD

The present application relates generally to information processing and, more particularly, to distributed computer processing and integrated robotics networks for lunar bases and space stations.

### BACKGROUND

NASA aims to return humans to the Moon with its Artemis program. Since the Moon is a three day trip with current propulsion technologies and only a three second communication delay from Earth, it can serve as a testbed for future deep exploration missions such as Mars and beyond. Further, the minerals and metals on the Moon can be utilized to manufacture parts for space applications, Low Earth Orbit (LEO) applications, and deep space missions. Helium-3, one of the rare isotopes on Earth, a primary fuel for nuclear fusion and rockets, is believed to be present in large quantities. If enough water is present, refueling stations can be established and used for deep space exploration. The next-generation telescopes can be constructed on the Moon's far side for detecting space threats such as asteroids, comets, and solar storms. Setting up the lunar base and other infrastructure has several challenges since the lunar surface poses a harsh environment for astronauts. The lunar environment is hazardous for astronauts to be involved in construction work due to solar and cosmic radiation, micro-meteoroid impacts, extreme temperature swings, and stick lunar dust. Once the base is established, operating and managing a base with humans alone will require large teams of humans, as was learned from two decades of ISS operations. Considering all of these factors, the lunar base needs to be designed to be agile and operate with few astronauts overseeing a wide range of long-duration, complex, and extensible tasks.

Given the importance of lunar bases, they require a novel infrastructure and support system. It is vitally important to ensure the base structures can protect the crew and systems from the hostile lunar surface elements with little to no vulnerability. Without the shielding of Earth's magnetosphere, all forms of electronics utilized in a lunar base will be susceptible to disruption due to more than twice as many charged particles from solar events and cosmic radiation. Without an atmosphere to slow down a constant stream of high velocity micrometeorites, any system exposed to vacuum would be susceptible to mechanical damage.

It is possible to shield bases from the radiation and bombardments by establishing the bases in the natural lava tubes, and the tempered temperature variation enables a location that is perfect for storage. But for the early stages of the base establishment, lava tubes can constrict the site selection process. The first lunar base needs to be in constant contact with terrestrial mission controls and a stable source of solar energy. Further, the lava tubes most likely contain valuable scientific data regarding the geological activity of the Moon and potentially much more. Before exploration systems have collected sufficient data, it is ill-advised to establish the first bases in lava tubes.

### BRIEF DESCRIPTION OF THE DRAWINGS

Reference should be made to the following detailed description which should be read in conjunction with the following figures, wherein like numerals represent like parts.

FIG. 1 is an illustrative example lunar pioneer base layout consistent with the present disclosure.

FIG. 2 is an example of a relatively flat system hierarchy structure, consistent with the present disclosure.

FIGS. 3A and 3B are examples of cross section design layouts of the pressurized chamber, consistent with the present disclosure.

FIG. 4 is an example of an ultra-wideband (UWB) transceiver development boards.

FIGS. 5A and 5B are examples of amount of computing power required per grid for different modes of computing, consistent with the present disclosure.

FIG. 6 is an example astronaut schedule for 24 hours used in the International Space Station (ISS) according to NASA.

FIG. 7 is an example algorithm implemented in MATLAB to simulate the entity traveling, consistent with the present disclosure.

FIG. 8 is an example of light trails generated an entity traveling at various speeds, consistent with the present disclosure.

FIG. 9 is an example algorithm for anchor-tag localization, consistent with the present disclosure.

FIG. 10 is an example of healthy computing units offloading work from damaged computing units, consistent with the present disclosure.

FIG. 11 is an example healing algorithm, consistent with the present disclosure.

FIG. 12 is an example of a forwarding table, consistent with the present disclosure.

FIG. 13 is an example of a schematic diagram for task allocations, consistent with the present disclosure.

FIGS. 14a-14d are an example of a solar flare healing strategy layout, consistent with the present disclosure.

FIG. 15 is an example of the processing power loss as tiles are damaged by the spreading fire in a 15×15 grid, consistent with the present disclosure.

FIGS. 16a-16d are an example of a spreading fire healing strategy layout, consistent with the present disclosure.

FIG. 17 is an example of processing power loss as tiles are damaged by radiation events in a 15×15 grid, consistent with the present disclosure.

FIG. 18 is an example system hierarchy of the tile network, consistent with the present disclosure.

FIG. 19 is an illustrative example of an architecture for smart asset management unit, consistent with the present disclosure.

FIG. 20 is an illustrative example of an architecture for internal robot control unit, consistent with the present disclosure.

FIG. 21 is an illustrative example of an internal robot that may operate inside the lunar base pressurized modules of FIGS. 3A and 3B, consistent with the present disclosure.

FIG. 22 is a table of various modes for internal rovers, consistent with the present disclosure.

FIG. 23 is an illustrative example of a flow diagram of an internal robot in nominal operation, consistent with the present disclosure.

FIG. 24 shows three illustrative examples of internal robot track designs, consistent with the present disclosure.

FIGS. 25A-25D are an illustrative example of a fire emergency response scenario, consistent with the present disclosure.

FIG. 26 is an illustrative example of a flow diagram for one possible fire response, consistent with the present disclosure.

FIG. 27 is an illustrative example of a flow diagram for one possible chemical spillover response, consistent with the present disclosure.

FIG. 28 is an illustrative example of a flammability map based on the materials' flammability level inside the lunar base, consistent with the present disclosure.

### DETAILED DESCRIPTION

The present disclosure is not limited in its application to the details of construction and the arrangement of components set forth in the following description or illustrated in the drawings. The examples described herein may be capable of other embodiments and of being practiced or being carried out in various ways. Also, it may be appreciated that the phraseology and terminology used herein is for the purpose of description and should not be regarded as limiting as such may be understood by one of skill in the art. Throughout the present description, like reference characters may indicate like structure throughout the several views, and such structure need not be separately discussed. Furthermore, any particular feature(s) of a particular exemplary embodiment may be equally applied to any other exemplary embodiment(s) of this specification as suitable. In other words, features between the various exemplary embodiments described herein are interchangeable, and not exclusive.

With landing sites chosen on the surface of the lunar south pole for mission success rates and scientific interests, it is likely that early bases may be established on the surface. Thus, given the hostile lunar environmental elements mentioned above, special consideration must be given to simplifying daily living activities and processing and storing critical data. The harsh lunar environment and the challenges of lunar habitation all could benefit from robotics and automation to perform the dull, dirty, and dangerous tasks including base management activities. Centralizing critical data and system operation in designated physical locations on the lunar surface is a significant vulnerability. What is needed is equipment and systems that can survive on the surface. Disclosed herein is a distributed computer processing and integrated robotics network designed to withstand the elements and shields mission critical resources.

The use of a spatially distributed computation framework disclosed herein for a lunar base offers some distinct advantages particularly in facilitating instantaneous asset tracking, performing spatial isolation of tasks, and using spatial neighboring systems to reconfigure and handle losses in computation capability. In addition, the spatial organization facilitates implementation of situational lighting and computation that are shown to provide significant energy savings. Spatial task decomposition is well suited for tasks such as base asset management (including tracking, retrieval, and storage) in volume restricted spaces, monitoring of hazards, fires, leaks, and other dangers that can result in the base being abandoned. Thanks to neighboring computational systems sharing tasks in cases of losses, the system is hyper redundant. The system is unlikely to face a total loss of capability instantaneously, rather the capabilities are intended to degrade gracefully. In the case of a base emergency, such graceful degradation would permit time for an astronaut team to evacuate safely or develop counter-measures to getting the base back to a nominal state.

There has been decades of research looking into distributed control networks, including papers that introduced the idea of decomposing control systems based on their tasks instead of based on the functional modules within. This easily incorporates the system requirement of concurrently keeping track of multiple tasks while avoiding conflicting them by following pre-programmed task priorities. To complete the tasks, the functional modules and their resource allocations easily fall into place. A low energy clustering-based routing protocol called “Low-Energy Adaptive Clustering Hierarchy” (LEACH) was developed for distributed networks. The distributed nodes are automatically divided into different clusters based on their system capabilities and topology, and each cluster elect a “cluster-head” that collect and distribute data, which are energy-intensive tasks. After a certain amount of time, the node with the most energy remaining becomes the new cluster-head. In an extensive network, the cluster heads can even elect a “super-cluster head,” forming the cluster hierarchy. This protocol reports to reduce the energy expended by eight times compared with simple direct transmission protocols. To provide further flexibility and versatility, another communication protocol was developed called “Adaptive Periodic Threshold-sensitive Energy Efficient Sensor Network Protocol” (APTEEN) upon LEACH.

The concept of distributed network also inspired the introduction of swarm robots. The planning and construction of a lunar human habitat may need teams of infrastructure robots cooperating to achieve a common goal. The major difference in this leap can be summarized as two points: the nodes are now mobile and dynamic, and they interact with the environment in a wider scope. Researchers have drawn inspirations from eusocial insects such as ants, termites, and bees. Termites in particular have evolved exceptional engineering talent building skyscraper-like nests called cathedral mounds equipped with temperature regulating internal heating and cooling shafts, in addition to facilities to farm food. Insects are particularly noted for their ability to build pathways and ramps utilizing amorphous construction methods. Some of these swarm robots have been designed to mimic identified key strategies used by eusocial insects to accomplish collective organization.

It has been demonstrated that decentralized algorithms for assembling a structure with modular robots and the robotic structure forms the end product. Algorithms avoids collision by arranging all robots into the expanded configuration, then each robot computes its neighboring branch, which collectively forms an “assembling tree.” This tells them their assembly action priorities. Finally, the robots follow the assembling tree and dock with each other magnetically in time O(log N). Also demonstrated was another decentralized flocking algorithm that allows a group of rovers to travel as a single swarm while avoiding collision with each other as well as environmental obstacles.

In addition, the technologies and architectures developed for “smart homes” are likely to be applicable to establishing a distributed network. There have been decades of research and development dedicated to the commercial smart home gadgets and the network supporting them by numerous technology corporations. These gadgets are permeating consumer's homes collecting and processing data. They operate independently in a distributed fashion. But their data may be collected by a smart hub, which will adjust their individual settings for optimized operation as a whole. For example, with monitoring and control over the power of all appliances across a home, the smart home may choose to stagger the operation of heavy power consuming appliances (e.g., washing machines, dishwashers) to alleviate the burden of the electric system of the house, and ultimate alleviating the power grid, preventing blackouts.

Smart homes also introduce the concept of “edge computing.” For a distributed network of sensors, the communication overhead would be tremendous with each of them collecting and transmitting raw data for processing. By employing a holistic view, the data transmitted should be standardized to eliminate the need for raw data, shifting the processing need from a central unit to the “edge,” where the data are collected. The sensors process the raw data and transmit the metadata instead. This distributes the processing power across the network, simplifying the communication overhead, greatly improving the scalability of the network.

Another inspiration to draw from smart home designs is the communication protocol between the units. Within the context of data processing on the lunar surface, wired protocols excels at data rate and reliability, but wireless protocols excels in flexibility and scalability. For wired protocols there are Ethernet, Universal Powerline Bus (UPB), Multimedia over Coax (MoCA), and KNX; for wireless protocols there are Wi-Fi, Bluetooth, Zigbee, Z-Wave, and 6LowPAN. One or a mix of some may be traded and implemented as platforms for lunar base distributed network.

These bases may include a distributed computing architecture that drives a network of robotics and sensor systems on the lunar surface with 6-20 human occupants. Local computing units may react to local events, first by coming out of sleep and then by providing situational awareness for robots and astronauts. Through this process, the base will deliver asset management/tracking, situational lighting, and robotic traffic management, to name a few services. Another service would be for computing units to provide look-ahead sensing and environmental alerts, including assessment of nearby threats, such as accumulation of smoke, fire, and toxic chemical residue that humans would otherwise not sense. This decentralized system would be able to constantly map these base threats and work towards first containing such situations while working with humans and robots to putting out the threat through improvised steps.

This decentralized architecture may be used to pool collective resources toward solving high-priority tasks or distribute them to solve several tasks in parallel. The major benefit is that the architecture is scalable and would connect local computing units to handle local tasks. Overall, this approach can keep the base's operation efficient, minimize energy spent in communication, minimize response times, and prevent the system from becoming saturated. Losses to individual computing units will result in neighboring units taking over the burden. This allows the system to ‘self-heal’ and ‘carry on’ from damaging events. Such a system is unlikely to face catastrophic failure or abrupt shutdown; rather, the performance will be degraded from accumulating losses, which can serve a critical role in emergencies in which human occupants can safely abandon the base if needed.

Disclosed herein is a lunar base as a facility with robotics playing an integral role in operating the base with the help of a distributive network and smart sensor units. These autonomous robots can handle emergencies that could be life-or-death situations for astronauts and, if not quickly managed, could result in the loss of an entire lunar base. The robots may move throughout the pressurized chambers by running along a rail track mounted, for example, onto the ceiling of the pressurized units. The tracks may run the length and breadth of the lunar base, and further, it may minimize direct human-robot interactions by default. This strategy is meant to offload certain tasks required for base operation to the robots, but with the robot remaining out of the way of humans. Significant challenges are expected in sending a single, complex monolithic robot capable of doing all the tasks autonomously. Utilizing a team of robots can mean quick, agile responses that may save precious base resources and avoid an escalation that could lead to astronaut injury or death.

In this decentralized approach, even if one robot is damaged or destroyed, the remaining robots continue to work to mitigate the emergency. Robots must respond quickly to emergencies in the base, such as fire, chemical spill, and biohazardous events. Given triple modular redundancy requirements for space systems, NASA emphasizes the systems architecture to be robust enough to handle lunar base operations. Addressing all the challenges, disclosed is a robot team and a network of sensors to handle emergencies on a manned lunar base. The computational backbone for this system may be a distributed computer architecture consisting of computing units, herein called tiles, of systems on a chip with sufficient radiation shielding for lunar surface conditions. The distributed network (tile network) maintains the day-to-day operation of the lunar base with the help of smart sensor units and robots. These local computer units may respond to local events by activating services when robots and astronauts are nearby. A vital service provided by the tiles would be to model and forecast smoke, fire, and chemical residue that are dangerous to the astronaut and need an immediate response. Importantly, this decentralized architecture can pool resources for computing offload and storing data for smart sensors and robots. In addition, computation is not done at a fixed central location. Instead, the location can be moved to minimize risks from an evolving emergency such as fire. Guidance, navigation, and control technologies for the networks of rovers and the smart sensor units are crucial on the lunar base for robust operations. Since multiple systems interact, delegating tasks and overseeing how they are carried out between systems is essential to avoid conflicts and duplicating tasks. Thus, planning, scheduling, and resource balancing are important elements. Disclosed is a robot system and strategy to mitigate emergencies such as fires and toxic spills. Given that these events will be rare, the intention is not to develop special-purpose fire or toxic spill-mitigating robots but rather design and assemble specialized kits utilized by a team of base robots to handle these special scenarios. The disclosed system includes a team of modular robots that can pick up specialized emergency response kits and work concurrently to tackle emergencies through a streamlined process.

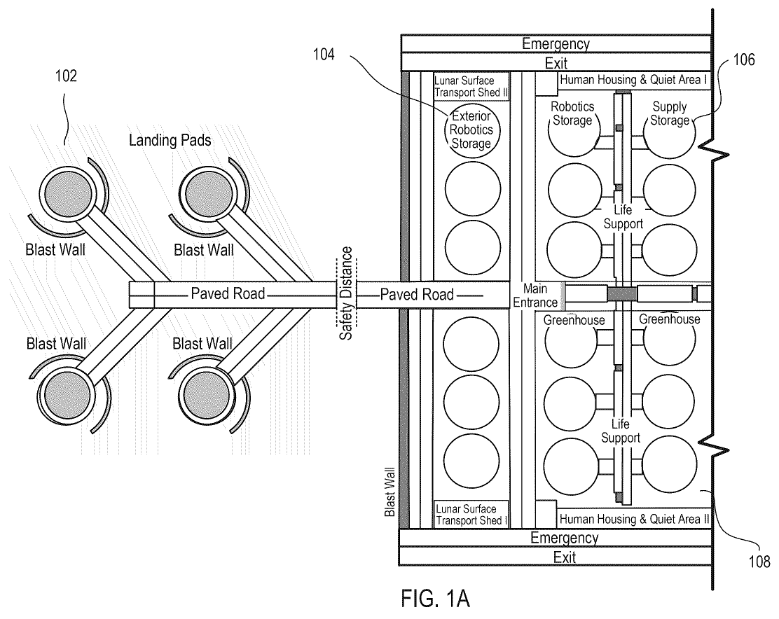

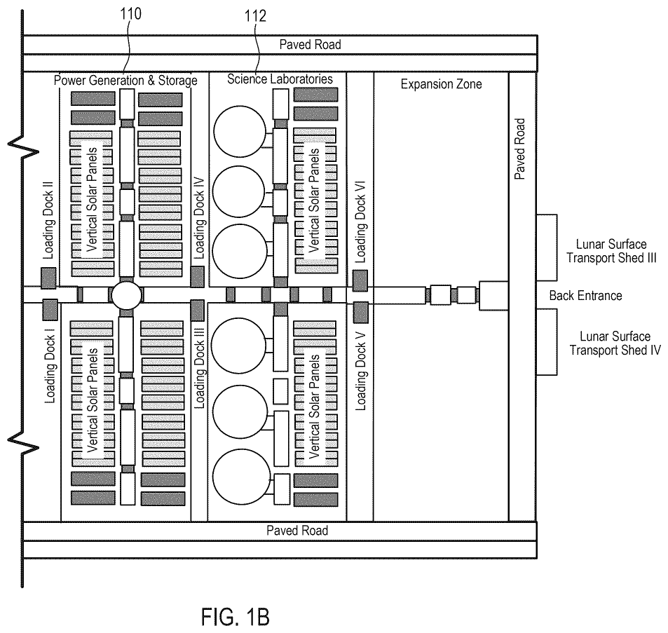

An illustrative example a pioneer lunar base layout 100 consistent with the present disclosure is shown in FIG. 1. In some embodiments, the base is divided into several zones distinguished by their functionality. Taking the lunar base layout in FIG. 1 as an example, there may be six distinguishable zones: the rocket landing/launching zone 102, the robotic depot zone 104, the supply depot zone 106, the greenhouse zone 108, the power generation zone 110, and the scientific zone 112. There is also a pressurized zone for the astronauts to work and live. The zones operate largely independent from each other except when appropriate (e.g., the power generation zone supplies power to all the other zones). The zones can be replicated and scaled as needed as the base expands and evolves. Different bases may involve different number and/or different zones. However, when a specific zone suffers a significant loss due to sudden catastrophe, the surviving zones will take on the processing power and attempt to recover the damaged data. The tasks processed are ranked by importance. For example, life-support systems and power generation are of the most importance, and scientific processing is of the least importance.

Each zone is lined with computing devices, or computer cluster tiles (CCTs, a.k.a. tiles), that are designed to facilitate the zone function. These CCTs are largely similar and are differentiated largely by the algorithm loaded within their microprocessors and the appropriate sensors implemented. They are able to communicate with each other in a short range, but together form a distributed network and their system hierarchy is even flatter with no central command.

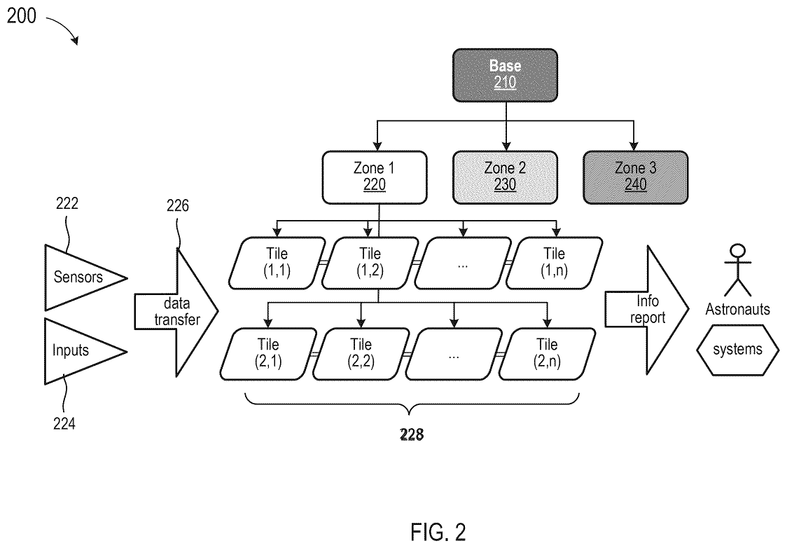

To increase the robustness of the lunar base infrastructure, FIG. 2 is an example of a relatively flat system hierarchy structure. In the example of FIG. 2, the system hierarchy may include a base 210, and the base 210 may include, for example, zone-1 220, zone-2 230, and zone-3-240. In another example, the base 210 may include more than three zones within. Some tiles in zone-1 220 can still be indiscriminately connected with others in zone-2 230. The tiles in tile grid 228 receive data through data transfer 226 from sensors 222 and manual inputs/logs 224. Agents such as astronauts query the tile grid 228 for information reports. This also enables feedback loops for automated systems.

The disclosed framework of an early lunar base can be replicated to other bases with different specificities, such as resource excavation camps and radio observatories. This disclosure will focus on building the framework for the first lunar base to ensure astronaut survival and routine operations.

In some embodiments, within each base there are various zones to further specify their functions. The zones have their allocated area appropriate to their uses and two different zones may have different shapes, which may result in a different number of tiles in each zone. While all tiles across the entire base may be very similar in terms of computing architecture and communication language, some tiles may have specialized sensors and peripherals required in their assigned zones. For example, some zones may require situational lighting, where only the area immediately surrounding the astronaut/rover may be lit, while other areas may remain dark to conserve energy.

In some embodiments, a tile consists of a cluster of computing units for creating a local network with other tiles, and the tile can connect with external units like smart sensor units and rovers to receive/transfer data and assign tasks. These external units typically have a local unit to process data. In addition, every external unit has a home tile to offload its computing process, and also the home tile can act as a memory resident for backup. An additional advantage of the tile network is that it makes a distributive network. If one tile fails, the neighboring units will offload the failed unit's tasks as described below.

FIG. 18 is an example system hierarchy of the tile network, consistent with the present disclosure. In the example of FIG. 18, the tile network 1804 is at the top of the hierarchy of the lunar base 1802. The overall operations of the lunar base 1802 are monitored and controlled through this network. The smart units, called secondary units, have sensors 1810 and actuators 1812, which are the primary units of the base. The smart control units may include internal robots 1814a and external rovers 1814b. In some embodiments, the smart sensor units may include, but are not limited to, smart lighting units 1808a, smart asset management units 1808b, smart internal environment monitoring 1808c, smart external environment monitoring 1808d, and smart life support monitoring units 1808e. These smart units transfer data between them through the tile network to perform the tasks assigned by the tile units or their own algorithm. The combination of these smart units supports performing all operations on the lunar base. In some embodiments, smart asset management units and internal rovers may be connected through the tile network to perform asset management.

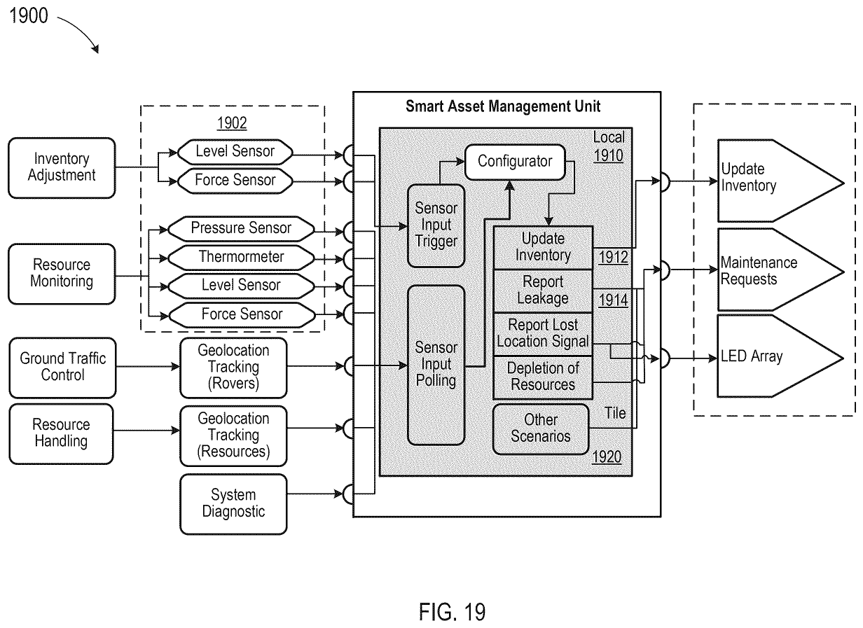

FIG. 19 is an illustrative example of an architecture for smart asset management unit 1900, consistent with the present disclosure. In the example of FIG. 19, local 1910 and tile 1920 represent the computing unit on the asset management unit and home tile, respectively. In some embodiments, the smart asset management unit receives data from the sensor units 1902 to monitor the asset. The basic operations listed inside the local box, such as updated inventory 1912 and report leakage 1914, are performed on the local system. Intensive operations such as monitoring many resources are transferred to the tile unit. The smart sensor unit activates the actuators units 1830 depending on the sensors data.

As shown in FIG. 19, the smart asset management units 1900 have the sensor units 1902 which may include, but are not limited to, pressure sensors, force sensors, and tracker sensors to update the resources on the base periodically on the tile network. The local system on the smart asset management unit 1900 can process data and transfer it to the tile to give updates frequently. It can transfer its computing processing/data if it cannot handle the processing. Thus, the smart asset management unit 1900 does not need high-performance computing or extensive storage units. These vast and modular capabilities make the smart unit an adequate option on the lunar base rather than having traditional sensors, as they require separate extensive computing units to track asset management.

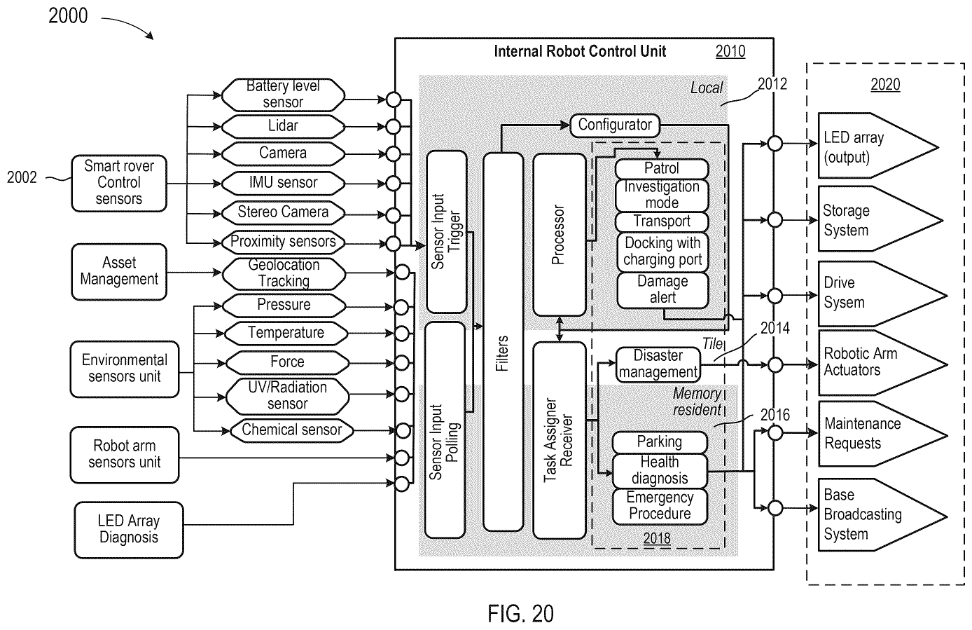

FIG. 20 is an illustrative example of an architecture for internal robot control unit 2000, consistent with the present disclosure. In some embodiments, the internal robot control unit 2000 consists of a minimal set of required sensors and a local (onboard) computing unit 2010 for its own guidance, navigation, and control (GNC) to operate autonomously. In the example of FIG. 20, local 2012, tile 2014, and memory resident 2016 represent the computing unit 2010 on the rover unit, the tile on which the rover is currently located, and the home tile, respectively. The smart control unit performs various operation modes on the local system, as shown in block 2018. Intensive operations like disaster management are transferred to the tile unit. The algorithm for routine operations like parking and health diagnosis can be transferred from the memory resident. The smart control unit activates the actuators units 2020.

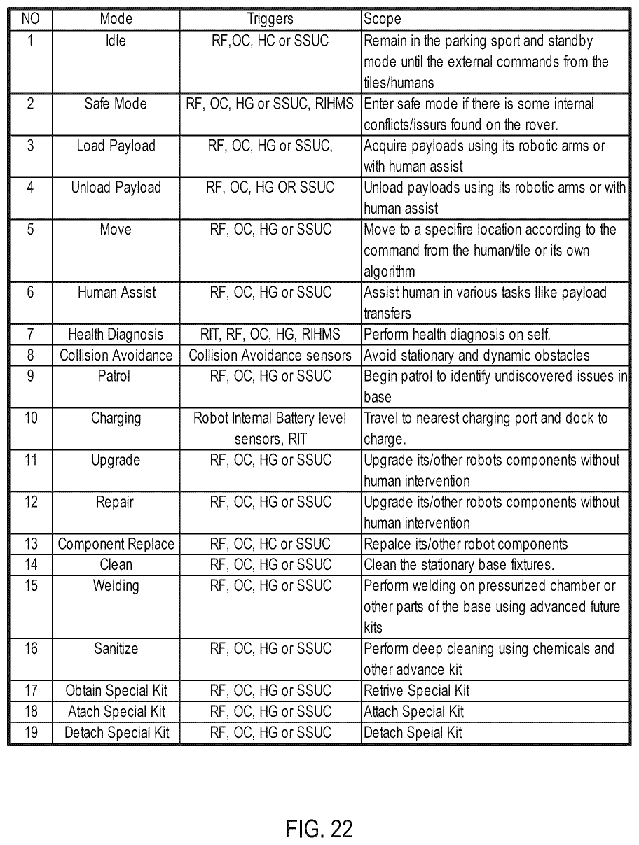

In some embodiments, the extensive computing and data processing may be performed on the tile units separately for additional capabilities and operations. Further, the rover may be assigned to a home tile unit that acts as a memory resident, which stores the algorithms for the backup and transfers some of the algorithms back to the rover regularly, such as routine health checks. These algorithms are not required to be stored inside the robots, and algorithms can be transferred from the home tile, eliminating the requirement of extensive computing and storage on the robot. Further, the robots may have multiple external advanced kits, typically advanced scanning units for finding leakage and repairing. They can be attached during extensive operation and removed during the nominal operation. The typical operation modes of the internal robots are shown in the table in FIG. 22. These modes can be triggered by commands from the tile network, human gesture moment, or smart sensors unit. The evolution algorithm can be introduced to have state-of-the-art rover capabilities and robust operations on the lunar base.

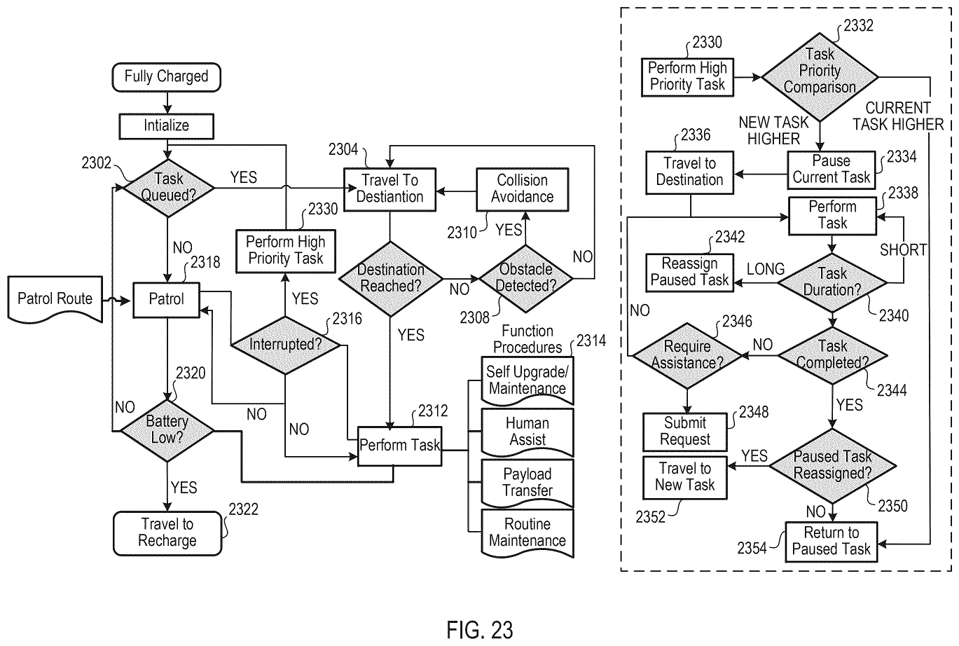

FIG. 23 is an illustrative example of a flow diagram of an internal robot in nominal operation, consistent with the present disclosure. In the example of FIG. 23, once a robot is fully charged and initialized, the system determines if a task for the robot is queued in 2302. If a task is queued for the robot, the robot travels to the destination for the task in 2304. If the destination has not been reached in 2306, then the robot determines if an obstacle is detected in 2308. If an obstacle is detected, then the robot performs collision avoidance 2310 and continues to travel to the destination. Once the destination has been reached, the robot will perform the queued task in 2312. The tasks may include, but are not limited to, a self-upgrade or maintenance, providing human assistance, a payload transfer, or routine maintenance functions. While the robot is performing the task in 2312, the robot may be interrupted in 2316 by a higher priority task 2330. If the robot has not been interrupted by a higher priority task, then the robot will complete the task. Also, while the robot is performing the task in 2312, the battery in the robot may run low in 2320. If the battery in the robot runs low, then the robot will travel to a charger in 2322 to recharge.

If there is no task queued in 2302, then the robot may enter a patrol mode. The robot may have an assigned patrol route that it follows unless it is interrupted in 2316 by a task to be performed. If the robot has not been interrupted, and no task is discovered while the robot is on patrol, and the robot detects that its battery is low in 2320, then the robot will travel to a charger in 2322 to recharge.

If the robot has been interrupted in 2316 by a higher priority task 2330, then the task priority of the robot's current task is compared to the task priority of the new task. If the task priority of the robot's current task is higher than the task priority of the new task, then the robot will return to the current task in 2354.

If the task priority of the new task is higher than the task priority of the robot's current task, then the robot will pause the current task in 2334 and travel to the destination of the new task in 2336. If the robot has reached its destination, then the robot will perform the new task in 2338. If the robot has not reached its destination, then it is determined in 2346 whether assistance is required. If assistance is required, then a request for assistance is submitted in 2348. If assistance is not required, then the robot will perform the new task in 2338. If the duration of the new task is determined to be short in 2340, then the robot will perform the new task and the paused task will not be reassigned. If the duration of the new task is determined not to be short, then the paused task is reassigned in 2342.

Once the new task is completed in 2344, the robot determines if the paused task has been reassigned. If the paused task has been reassigned, then the robot travels to a new task in 2352. If the paused task has not been reassigned, then the robot returns to the paused task in 2354.

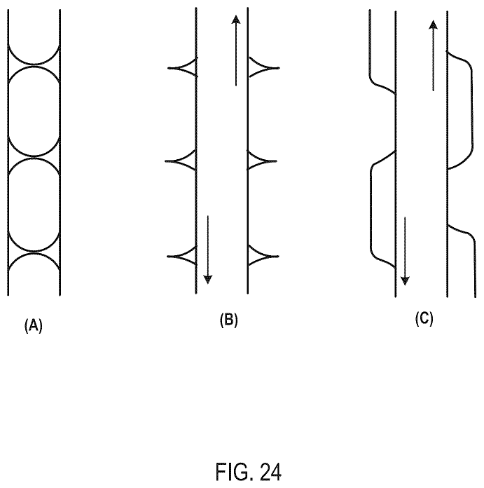

With several robots traveling simultaneously around the base interior, they are prone to become obstacles for other robots and bottleneck the autonomous task performing. Traffic is even more likely to occur when some tasks require the robots to be stationary, while others require the robots to be in constant motion. In some embodiments, therefore, the disclosed system adopts the railway philosophy, as the robots only travel on tracks. Various embodiments may employ one of the following three track designs to resolve the traffic issue. FIG. 24 shows three illustrative examples of internal robot track designs, consistent with the present disclosure. In the example of FIG. 24, arrows represent the route of the robots. The tracks eventually converge near the termination of the base corridors. In the first design, FIG. 24 (a) shows a cross track design. As the robots stops at the straight tracks to perform tasks, the passing robots can use the cross tracks to bypass the stopped robot. This also requires the passing robot to enter the opposite direction track temporarily. This track design, therefore, has no predefined travel direction. This design also introduces no extra infrastructure to the surrounding, but takes advantage of the space between the tracks, which can be considered as less utilizable space. However, this requires heavier processing power on the traffic management algorithm on the robots or on the tile network server.

In the second and the third design, robots stopping to perform tasks can enter the stopping stations (FIG. 24 (b)) and regions (FIG. 24 (c)). The passing robot does not need to consider the stopped robot as it is out of the way. Also, the passing robot does not enter the opposing direction track. This design, however, encroaches on the surrounding space. As the base expands and develops, the stopping stations/regions may restrict the customization options within the base, as some space may be out of reach.

In some embodiments, the tiles are mostly made of durable materials launched from Earth. The mechanical and electrical designs are beyond the scope of this disclosure. In an illustrative example embodiment, the tiles may have hard shells and a surface area of, for example, 1 m×1 m with tens of centimeters of thickness. The tile contains the necessary electrical modules within the shells and have ports on the exterior sides to interface with neighboring tiles. There may be a cavity within the shell. It may be filled with lunar regolith to provide further structural integrity, temperature isolation and radiation shielding, reducing the launch budget of the base. In this case, the components within the tile shell are well contained to avoid contamination with regolith.

In some embodiments, each tile consists of several single-board computers (SBC) hardened for lunar surface application. These SBCs may be closely coupled within the tile to form a monolithic unit as seen from external systems. Together they provide the accumulated data processing, transmission, and power distribution of the tile. The tasks to be processed are delegated among these SBCs by one SBC which acts as the tile leader. This tile leader is arbitrarily assigned and can always be reassigned if necessary.

The communication between tiles may be either through wires or wireless. Wired connection requires negligible power and is extremely reliable for long duration. This enables the modularity of the tiles as it is able to be scaled. Yet they require complex designs in the interfaces between the tiles. As most tiles are assembled via robots, extra resources are required to ensure proper engagements. Moreover, the loose lunar dust statically charged on the base surface may also interfere with the interface mechanically and cause irreparable damage.

Wireless connections require low, although not negligible, power. Wireless connections allows the design of the tiles to be sealed before launch, avoiding lunar regolith contamination during deployment. But the wireless network setup and maintenance require extra overhead and complicates the design, especially in enabling the modularity as the tile grid expands. The communication range may be limited by design to reduce design overhead each tile will only communicate with, for example, the 4 or 8 immediate neighbors instead of more distant tiles.

Together, the tiles forming the zones, which forms the entire base, provide a robust and stable processing backbone server to the entities associated to this base, like clients. These clients query the tile cluster server for data and updates tile cluster server (actively or passively) if necessary. Their designs are beyond the scope of this disclosure, but client-server I/O is standardized to ensure modularity. They may be, for example, electronics in astronauts' EVA suits, rovers, and habitat modules. The clients should be equipped with extra processing power and I/O converter for their specific needs.

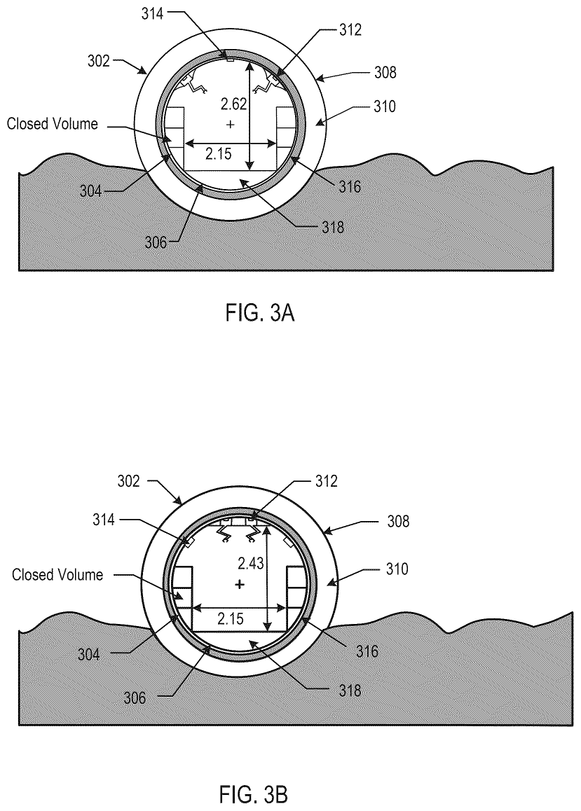

In some embodiments, the pressurized region interior design is inspired by existing designs of cylindrical modules. In one previous example, cylinders were designed 17 meters in length and 6 meters in outer diameter 302, with an inner hull 306 having a diameter 304 of 4 meters. The outer walls 308 of these modules would have a double shell consisting of 0.25 meters foam glass heat insulation 316 and 0.65 meters of regolith shielding 310. This design was proposed to be launched by an Ariane Rocket with a payload with a 6-meter diameter. Due to the launch vehicle selection, disclosed herein is a smaller design of 4.5-meter diameter. The components are scaled down appropriately as shown in the examples of FIG. 3A and FIG. 3B. FIGS. 3A and 3B illustrate wo examples of the cross section design layout of the pressurized chamber 300. The two design layout are differentiated by the robot transportation railing 314 and lighting 312 placements. The pressurized chamber 300 may also include a chase 318 to hold, for example, computer and electrical wiring.

The design of the disclosed system also referred to NASA's Human Integration Design Handbook for recommendations of open space for human movements and reaches. Having the knowledge of the human physical reach, which is nominally 80 centimeters, guided the creation of a spacious and comfortable habitat for astronauts to live in. Within the disclosed system, a normal sized person is able to fully extend their arms standing near the center of the pathway. For modules that are 17 meters long, the total free volume would be 88 cubic meters (70% of the total interior volume), providing sufficient space for several astronauts at a time.

The main challenge to having the robot do all the tasks autonomously is that it needs to be equipped with as many sensors as possible for making decisions quickly and accurately and for redundancy, especially in extreme environments like the lunar surface. Thus, it leads to a big, clunky robot and results in slow response for handling tasks. Further, launching large and heavy robots to the lunar base would not be preferable due to the launch cost and volume constraints imposed by the launch vehicles. In addition, the robot will be on the ceiling of the pressurized chamber, which limits the size of the robot. The robots must be agile and respond quickly with swarm capabilities to emergency scenarios inside the lunar base without interfering with other operations. Extensive computing capabilities with seamless data transfer and communication should exist inside the lunar base to handle the robot tasks effectively. To address these challenges, the disclosed tile network and smart sensor units connect with robots to offload heavy computing tasks and facilitate communication and data transfer to handle day-to-day lunar operations effectively. The tile computing unit wakes up for local events when astronauts or robots are nearby by activating services. The robots move along the ceiling using a rail track on the pressurized chambers to minimize unnecessary encounters with human occupants while maximizing speed and productivity.

The robot workspace will be inside the pressurized area as the internal robot performs tasks inside the lunar base. A main challenge to having the robot in the pressurized chamber is the robot sharing a common workspace with astronauts. Thus, the disclosed robot operates on wheels and may travel using a rail network embedded into the ceiling of the pressurized modules, as shown in FIG. 3A, to minimize the workspace between robots and astronauts.

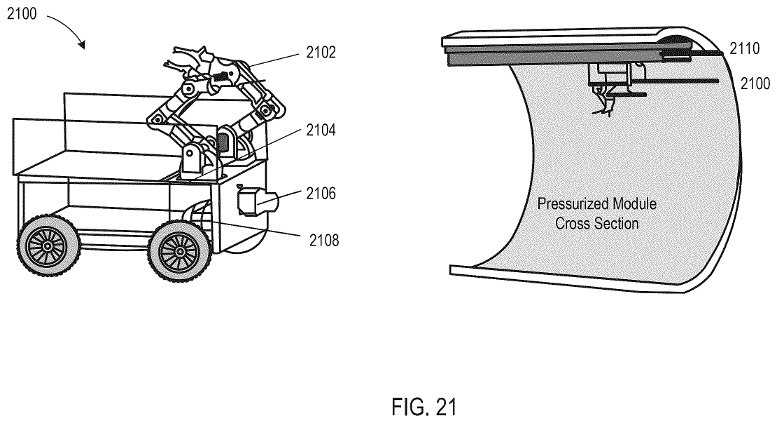

There is an important need for developing and utilizing a team of robots to perform the routine dull, dirty, and dangerous tasks inside the base. FIG. 21 is an illustrative example of an internal robot 2100 that may operate inside the lunar base pressurized modules of FIGS. 3A and 3B, consistent with the present disclosure. The example robot of FIG. 21 may include robotic arm 2102, payload box 2104, light detection and ranging (LIDAR) module camera 2106, and onboard computer batteries 2108.

In some embodiments, the robot may operate on wheels yet travel using a rail network embedded into the ceiling of the pressurized modules, such as ceiling rail network 2110 of FIG. 21. In the example of FIG. 21, internal robot 2100 can be seen traversing ceiling rail network 2110. This innovative approach permits these robots to rapidly respond to needs at any corner of the base. Robots can perform these tasks to assist humans and do tasks efficiently. Current robots are advanced and smart enough to operate autonomously without human input. However, there are many challenges and constraints to having robots on the lunar base. Autonomous rovers need as many sensors as possible for making decisions quickly and accurately and for redundancy, especially in extreme environments like the lunar surface. In addition, they require extensive computation power to process large quantities of sensor data. These lead to an increase in the size of rovers.

Launching large and heavy robots to the lunar base is not a preferable solution due to the important need to constrain mass and volume. The size limits on the robots will pose challenges to interact with humans inside the pressurized chambers, since the robots will share the common workspace with humans. The safety of the human occupants is paramount. Further, these robots should respond quickly to emergencies like fire and exploit swarming capabilities. All of these capabilities will require a computational and data-processing backbone for the robots that can be readily scaled up.

To address these challenges, the disclosed tile computing network and smart sensors units are present on the lunar base rather than a remote location and will be actively supporting the team of internal robots. The tile computing units can help to offload heavy computational tasks executed by the robots. In addition, the tile network may run tasks for long periods of time without having to dedicate a robot. The robots in turn may move onto other tasks to be completed concurrently. Since the robots operate by moving along the ceiling using a rail track, this minimizes unnecessary encounters with human occupants while maximizing speed and productivity.

With most of the resources on the lunar base being managed by automated systems and rovers, it may be a significant task to localize the systems, rovers, and the resources. Even though, for example, the traffic of the automated rovers are most likely planned beforehand, their location should be tracked by a separate system to establish redundancy, in case the internal tracking mechanisms in the rovers fail while carrying out critical tasks. Further, keeping track of the location of different types of critical resources at all times may reduce waste, especially when they are needed in emergency situations.

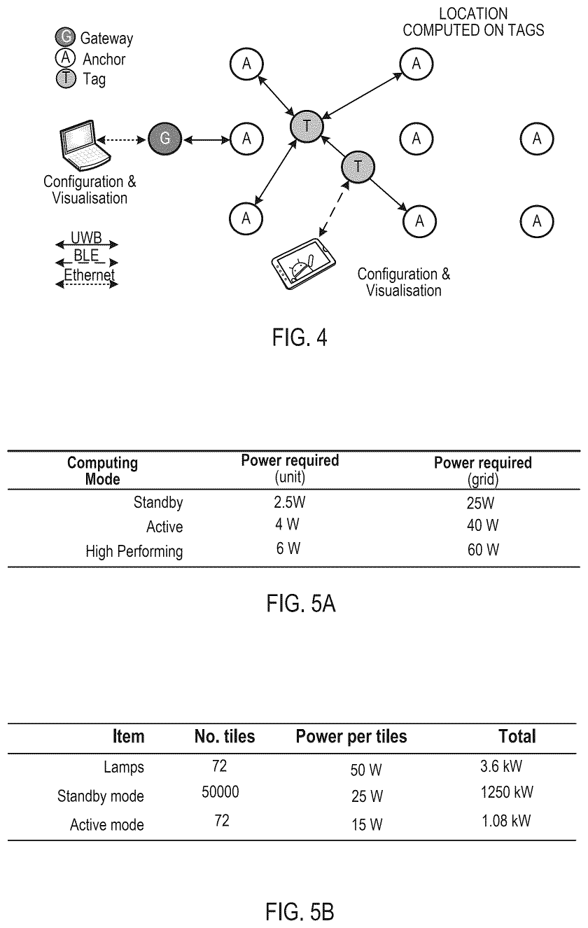

Existing commercial-off-the-shelf (COTS) systems are available to keep track of inventory and automated movers by use of “tags” on items to be tracked. For example, automated warehouse management requires real-time tracking of robotic movers and the inventory they carry. There are different communication technologies employed. In some embodiments, the disclosed system employs a localization system that utilizes the ultra-wideband (UWB) radio communication protocol. This protocol uses low power (~0.1 W) and allows concurrent multiple-agent low-range communication. For example, a (UWB) transceiver development board developed by Qorvo and deployed as illustrated in FIG. 4 may be used. Another development board can be initiated to be the “Gateway,” but it is not necessary to for the anchors to track the tags. The configuration and visualization tablet is not necessary for routine operation after initialization.

In various embodiments, the boards can be set up either as stationary anchors or mobile tags with their proprietary software. The anchor boards are placed in different spots around the room and the tags are attached to the entities of interest to be located. There is no inherent communication hierarchy among the anchors or the tags. One of the anchors can be chosen as the origin of the coordinate system. The relative distances of the anchors are determined automatically, although it is possible to manually input distance measurements between them. Using a computing device, e.g., an Android tablet, their proprietary software can also visualize the location of the anchors and the movements of tags in real-time. Since this system uses time-difference triangulation technology, a multiple-anchor distributed setup is required to track one or many tags.

In the lunar base setting, the system employs similar technologies with hardware more suitable for the space environment. The anchors are deployed in most tiles and placed strategically. Given the short range of the UWB technology, the anchor separation can be determined by the density and the tile dimensions. The tags are placed on rovers, critical resource containers, or other systems that are mobile and need to be located at all times. The locations of the tags are monitored and stored by the anchor units and transferred to clients to be processed and visualized.

The distributed computing network consists of collection of computing units. In various embodiments, the computing units may perform their tasks independently without waiting for the command from outside source. The computing unit might be a highly powerful computer or small plug computer. In context of lunar exploration, it is important to reduce the cost as well the power consumption by these computing units. Further, it is preferred to have a distributed computing network rather than a centralized one in the unknown hostile environment. In case of any disaster, the affected area can be isolated without disturbing unaffected area's functions. It may be possible in a disturbed network to transfer the tasks to the neighboring computing units from the failed computing units. The redundancy, robustness, energy efficient and cost effectiveness are the main parameters in computing tasks in any kind of exploration mission. Thus, the system disclosed herein may have the computing units on the ground tiles and may reduce the power consumption by introducing various mode of computing.

The mode the computing unit is in depends on the tasks being performed on the computing unit. In some embodiments, the system may categorize three type of computing modes according to tasks and disaster management. The three types of computing modes may be, for example, standby mode, where the computing unit reduces its all other activities except getting data from its sensors to lookup for the wakeup call to set up the environment for incoming entity; active mode, where the computing units runs the code in a loop to maintain the environment for entity to work; and high performance mode, where, in case of disaster, the neighboring computing unit offloads the computing load of failure units along with its own computing load.

The computing network may be localized inside the grid to have higher computing power and for redundancy. In some embodiments, the system uses Raspberry Pi as a computing unit since it is cost effective and able to operate into different modes of computing as mentioned above. Ten Raspberry Pi per grid are assumed and evaluated. The amount of computing power required per grid for the different mode of computing as shown in the table in FIG. 5A.

In some embodiments, to save power, situational lighting may be used, and the computing network may be operated in standby mode when no entity is on the grid and later it may turn into active mode once it detects the entity present on the grid. For example, 37.5% of power per grid may be saved using standby mode in the situational lighting case. For an example lunar base that consists of 50,000 grid then the total power required for standby mode may be, for example, 1,250 kilowatts (kW). As discussed above, the situational lighting for nine entities requires an additional 1,080 W of power for 72 tiles (8 tiles per entity) to operate in the active mode. The power consumption in this mode is shown in the table in FIG. 5B.

The total power required in the situational lighting is 1,255 kW. Considering a solar panel with 1,360 watts per square meter (W/m 2) power generations and 30% efficacy, the system requires approximately 3,100 solar panels for internal situational lighting to light up lamps as well power the computing units in standby and active modes. However, the number of solar panels required for the conventional lighting setup is approximately 12,500 (50,000 grids×2 lamps with 25 W), which is four times more than situational lighting.

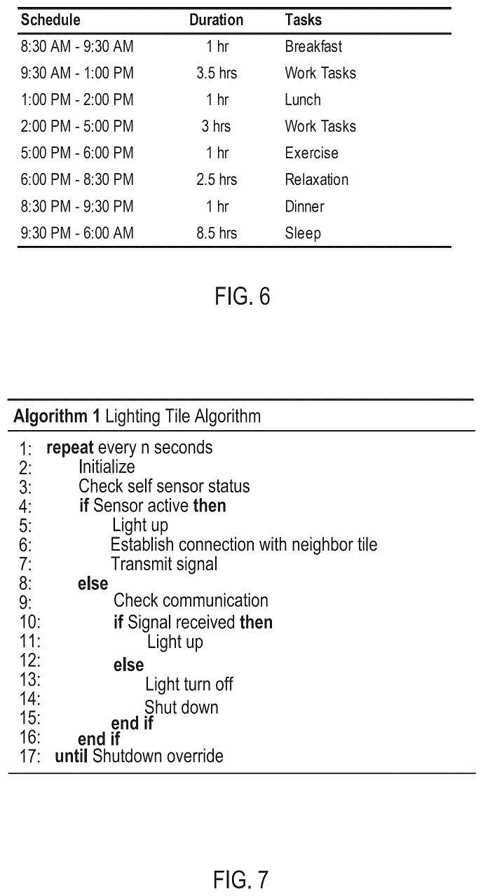

Situational lighting is where the light source “follows” the entity and its surrounding space. The entity can be an astronaut or a rover moving inside the lunar base. This type of lighting method can save power substantially over conventional lighting strategy, where the entire room lighting is on or off. To find the reduction in power consumption by situational lighting over conventional lighting setup, assume an astronaut is walking on the grids on a typical day. The astronaut schedule for 24 hours used in ISS according to NASA is shown in the table of FIG. 6.

An example lighting system consists of two linear style LEDs with 3,500 lumen (5,000 K Temperature) in each grid tile. These LEDs each require 25 W to light up. There may also be low-power sensors employing rudimentary mechanisms to detect the presence of the entity on the tile itself. The design of the sensor system may be, for example, a simple circuit that determines the resistance change of force-sensitive resistors covering a significant region of the tile. This mechanism requires no power to run except that required for the microprocessor, and its sensitivity can be easily modified, and it is relatively durable. Another example may be infrared detectors and other wireless proximity detectors, but they generally require higher power and extra infrastructure and maintenance and are more expensive.

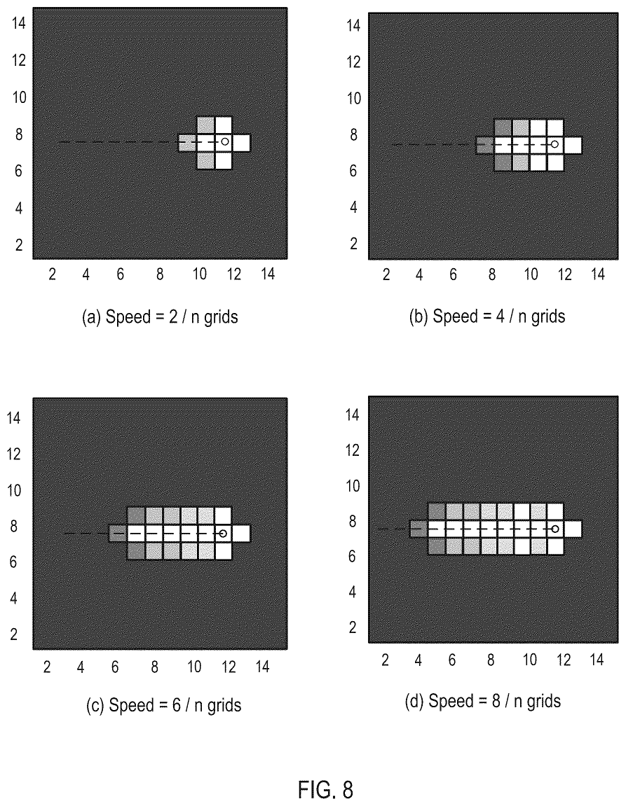

To simulate the entity traveling, a pseudocode in Algorithm 1 (see FIG. 7) is implemented in MATLAB. By implementing the lighting tile algorithm listed at Algorithm 1, an entity moving on a 15×15 grid inside the workspace may be simulated. In the simulation, the position of the entity is kept secret from the tiles but was separately discovered by the tiles. Following the algorithm, 5 tiles will light up with the center being the entity's current position. As the entity travels, with algorithm repeating every n seconds, it is possible for the entity to travel several grids within the n seconds. This means the entity will create a light-trail the faster it travels the longer the light trail will be. This is observed with FIG. 8. FIG. 8 is an example of light trails generated an entity traveling at various speeds. The example light trails are generated by an entity traveling at various speeds on a 15×15 lighting tile grid. All none-black tiles represent a lit tile, with shades of gray representing lit tiles along entity's path. The dotted line represent the path the entity takes. The circle represents entity's current position. More tiles will be lit if the entity travels faster.

However, as mentioned above, different numbers of grids will light up depending on the relative speed of the entity, as well as the number of entities within the same grid. The power reduction estimation listed above may be slightly inflated as a result. But it should be noted that with a reduced gravity as well as safety considerations, entities on the lunar surface do not travel very fast (~0.25 m/s), and traffic density is rarely dense. This power reduction is scalable by design. Thus, situational lighting tiles provide a considerable energy saving solution for the lunar base.

On the lunar base, there are many critical systems and resources distributed across all areas. It is important to locate them in a timely manner, especially if they are required to resolve an emergency. Some resources may have their designated areas, e.g., fire extinguishers and emergency oxygen tanks. But not all emergencies are foreseeable, and all resources are critical in some circumstances.

Since it may be safely assumed that most resources are mobile in an early lunar base, especially when it is being established and/or expanded, the system may keep track of the locations of the resources if they are relocated, and the amounts of consumable resources need to be monitored for routine maintenance. These can be accomplished by rovers and astronauts as they relocate and consume these resources in theory. The rovers will know what it is relocating with some sensors and programming and the astronauts can manually log the activities. However, both astronauts and rovers may make mistakes. The astronauts may make an erroneous entry in their logs, and the rovers may malfunction during resource relocation.

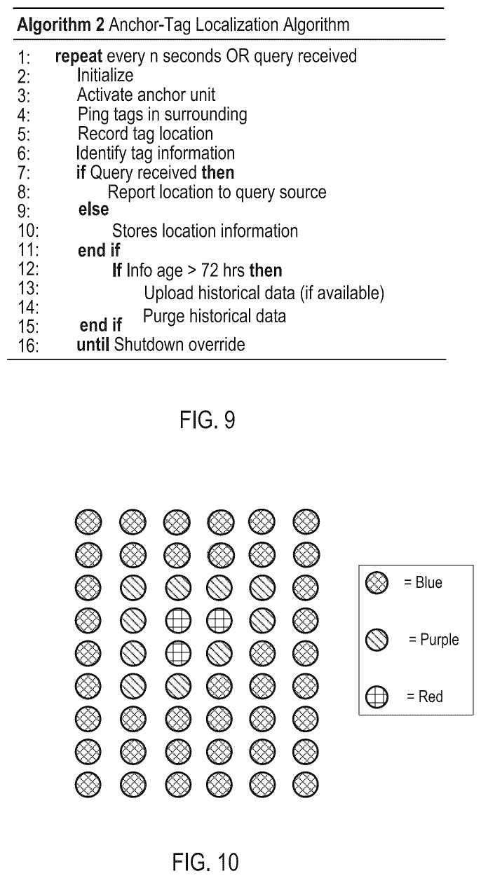

To provide a further layer of redundancy to ensure the robustness of the lunar base, the system utilizes the CCTs to keep track of the locations of all the resources. As illustrated above, there exist mature and commercially available technologies that employ time-difference triangulation algorithms that allows the CCT network to accomplish inventory localization. See FIG. 9 for an example algorithm for anchor-tag localization.

By having the tiles as “anchors,” and appending reassignable “tags” to the resource containers, the location of these “tags” can be obtained readily and at a moment's notice. The anchors are only able to detect tags within a short range but can keep track of multiple tags concurrently. Yet their location data can be stored and distributed across the entire base wherever a CCT is located. To reduce power consumption and computing labor, the anchors can ping to locate the tags in regular intervals at idle/standby times, similar to the way lighting units query sensors in regular intervals. Moreover, in emergency situations where locations of critical resources are required as soon as possible, the inquiring party may submit the query to their closest CCT. The network will first retrieve the location from their stored memory, and then they will ask the anchors to ping for tags again for a most up-to-date location and update the inquiring party.

As mentioned above, the tags may be reassignable. If the resource container is depleted and should be filled with a different resource, an astronaut or rover can reassign the tag to represent the correct resource. This improves the lifetime of the localization system.

A failure in systems can occur at any time in the extreme environment like the lunar surface. Repairing and replacing the damaged units is very difficult since it requires autonomous and complex operations. However, the failure of hardware in a computing unit is unavoidable and tasks depend on failure hardware cannot be performed. Further, the subsequent tasks that depend on the unperformed tasks will also be affected. In case of emergency where some of the CCT suffer losses, the rest of system should perform normally to avoid catastrophic failure by design. But the lost processing power could have long-lasting effects if left unchecked. Thus, the network may be independent and robust to handle the disasters.

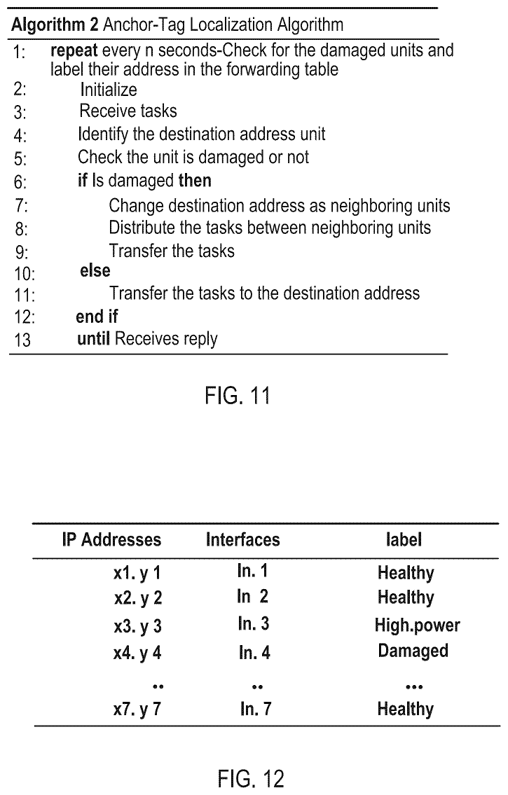

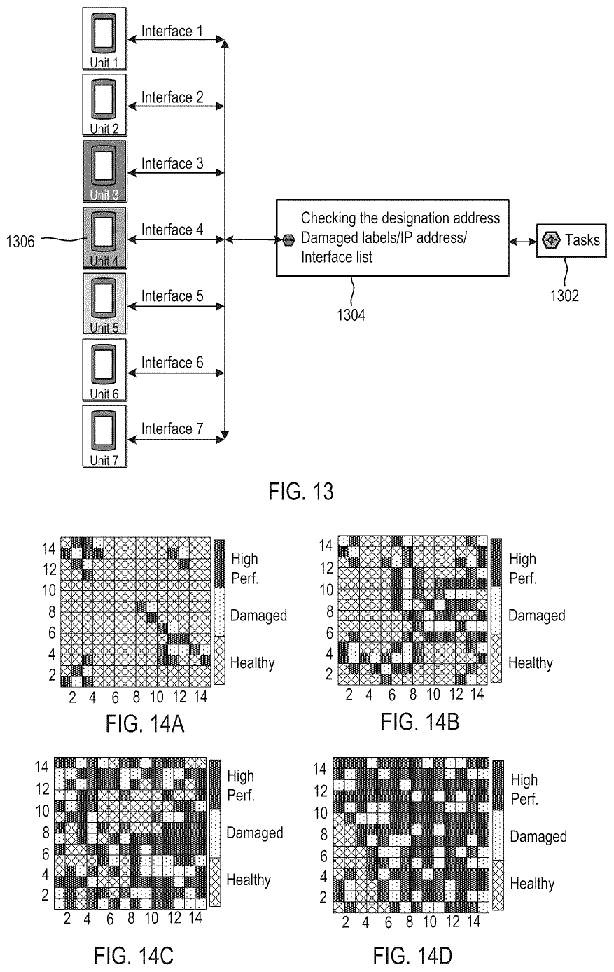

The disclosed system includes a high performance mode to these CCTs, in that the computing load of failed units can be distributed partially (n to 1) or wholly (1 to 1) to neighboring healthy units. As seen in the example of FIG. 10, when the damage occur in the computing units, the neighboring computing units turn on their high performance mode by executing code and processing data for the damaged units. The tasks allocations, as shown in FIG. 13, can be performed in the forwarding table itself (see FIG. 12). When the tasks 1302 are received from the source, the forwarding table looks for the designation address and for the interface to transfer the tasks 1302 to the designation unit. A sample forwarding table is shown in Table 4. This sample assumes that the information of damaged units is labeled in the forwarding table so that the tasks 1302 transformation to the damaged units cannot be avoided. Whenever the forwarding table receives the tasks 1302 for the damaged units, it will change the designation address to the addresses of adjacent units. As shown in FIG. 13, the unit-4 1306 has been damaged, so inside forwarding table the tasks 1302 for unit-4 1306 have been allocated to the neighboring units 3 and 5 by changing designation address of the tasks 1302 as well the interface. Since the computing tasks are distributed to neighboring units, the healing has been done with these neighboring units. The algorithm for the healing is defined in algorithm 3, which is shown in FIG. 11.

Since this is only a temporary fix, the damaged CCTs will need to be replaced immediately. Therefore, as soon as neighboring tiles initiate the high performance mode, they will report the damage to astronauts and rovers for emergency inspection and repair.

In the case of widespread CCT losses, either by computation errors or major solar events, entire zones will suffer losses. In these cases, it is impossible for the surviving tiles to perform twice (or more) as much as nominal. In the case that critical systems suffers failures (e.g., life support), the less critical CCT networks will abandon their tasks and take over the operations of the failed networks. This provides the astronauts and critical systems with more time to execute emergency procedures (e.g., data backup, evacuate base). This significantly improves the survival rate of the astronauts, especially compared to base designs that centralizes the processing of critical tasks.

To demonstrate the robustness of the healing strategy, two scenarios were simulated, a solar flare events and a base fire breakout to quantify the increase in robustness. A solar flare event is a localized intense eruption of radiation in the sun's atmosphere. Solar flare events eject high energy charged particles towards a specific direction from the sun's surface. These charged particles can affect any electronic device in its path via single-event upsets or other fatal damages. Most solar flare events do not reach the Earth's surface since its magnetic field and atmosphere can block it. The moon does not have a magnetosphere, so the systems exposed on the lunar surface are susceptible to damages caused by solar flares. The healing algorithm on the tiles are designed to harden the grids against these events. FIGS. 14a-14d is an illustrative example of a solar flare healing strategy layout. Within the 15×15 grid, a random distribution of tiles would be destroyed by radiation events.

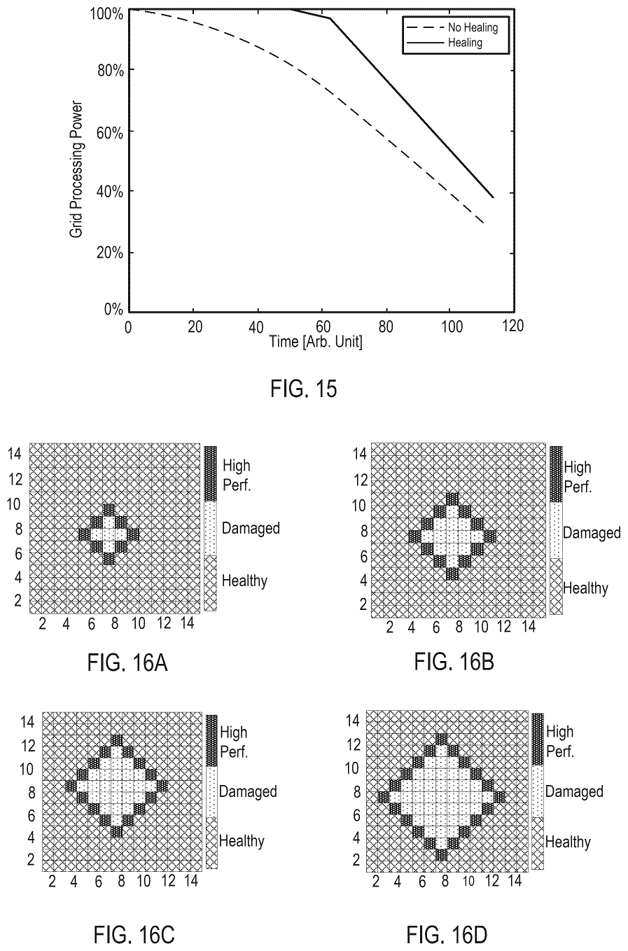

The simulation assumed that the solar flare events damaged 5%, 15%, 25%, and 30% of the units. An algorithm has been implemented to sustain to the grid total processing power. As can be observed in the results shown in FIGS. 14a-14d, the healthy unit turns into a high performance mode to compensate for the computing units of damaged units. Depending on the number of units damaged and the designed computing overload than nominal scale, the grid total processing power is calculated, and results are shown in FIG. 15.

FIG. 15 is a graph illustrating an example processing power loss as tiles are damaged by the spreading fire in a 15×15 grid. Each damaged tile's processing power is distributed to three other healthy tiles in this case. With healing strategy in place, the processing power deteriorates much slower. As can be seen in FIG. 15, the computing processing power is maintained till a certain percentage of damaged units, then the processing power decreases as the number of healthy units are not available to compensate for the damaged units.

The second example simulated is a spreading fire. Although the lunar surface is a nearly vacuum environment, there will still be pressurized regions with oxygen for fire to spread. Within these regions there will be contingencies for fire containment and elimination. The simulation assumed the worst case scenario, where all other automated contingencies have failed and the fire spreading is relentless and spreads radially, as visualized in FIGS. 16a-16d. Note that this could also apply to any causes (that occurs in vacuum) that result in radial spread of tile failures, e.g., liquid resource leakage. FIG. 16 illustrates a simulated spreading fire healing strategy layout. Within the 15×15 grid, a fire breaks out at the center and spreads radially, damaging the tiles on its way (turn from blue to red).

FIG. 16a shows the spread of the fire as a tile loss at a time t=0, FIG. 16b shows the spread of the fire as a tile loss at a time t=1, FIG. 16c shows the spread of the fire as a tile loss at a time t=2, and FIG. 16d shows the spread of the fire as a tile loss at a time t=3. The high performance tiles locations are determined by the distribution of the damaged tiles.

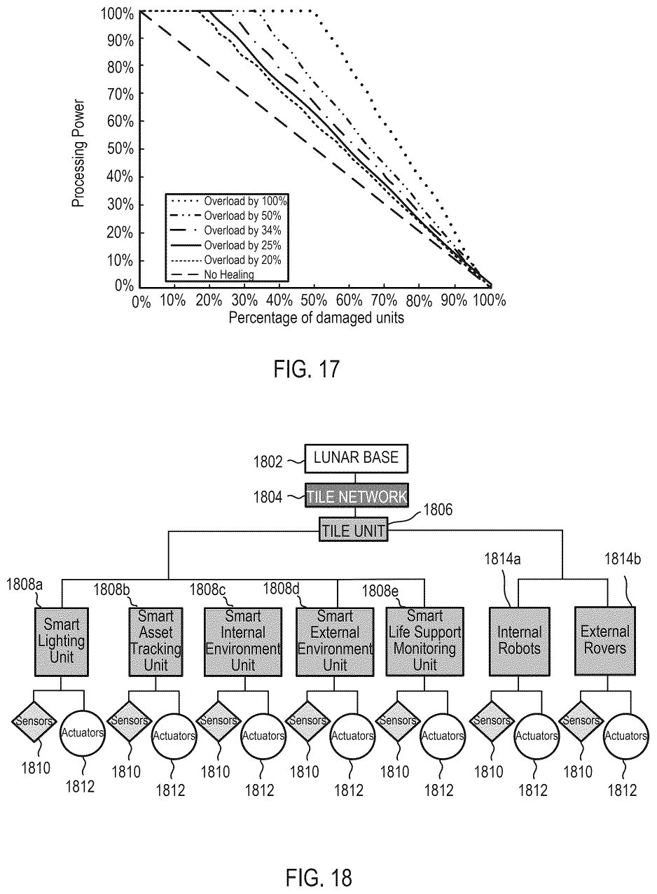

With the healing algorithm implemented, it can be observed that in a 15×15 tile grid, the total processing power drop-off occurs much slower. In FIG. 17, the dashed line indicates a network grid without the healing algorithm. As soon as fire starts at t=0, the total processing power begins to drop off. Yet if each tile is able to overload by ⅓ of another tile (3 healthy tiles replacing 1 damaged tile), the grid processing power remains unfazed for some time before gradually dropping off. This delays the effect of spreading fire, providing the systems and astronauts precious extra time to react and execute other manual contingencies, including evacuation. FIG. 17 illustrates the processing power loss as tiles are damaged by radiation events in a 15×15 grid. With tiles able to overload different amounts in high performance mode, the processing power remains at 100% even if some tiles are damaged. With higher overload capability, the grid is more robust.

In some embodiments, the Message Queuing Telemetry Transport (MQTT) protocol is used. MQTT is a machine-to-machine connectivity protocol for the Internet of Things. In order to send and receive instructions for machine-to-machine telemetry in low bandwidth conditions, MQTT is utilized as a lightweight publish-and subscribe protocol. MQTT attain create advantages such as low power consumption, reduced data installation size, and effective information delivery to a single or a large number of computing units. MQTT Protocol is divided in a process with a few instructions. MQTT follows a publish-and-subscribe protocol which means that it acts a middle server between the publishers and receivers. A device can subscribe to a message on a topic in the MQTT broker and receive messages or instruction whenever there is an update to that topic by other devices who publish a message or instruction. A MQTT broker serves as the center of the publish-and subscribe protocol, processing instructions and messages, monitoring clients and receivers, and filtering messages and instructions exchange. Additionally, the broker keeps track of all persistent client sessions so that subscriptions and any delayed or interrupted messages can still be preserved and viewed.

Further, Mosquitto is a message broker that implements several versions of the MQTT protocol, including the latest 5.0 revision. This type of broker can provide access to huge range of devices which can exceed 60,000 publishers but not receivers. In space, such broker can be implemented for thousands of microprocessors with the aid of dual bandwidth routers that will increase the bandwidth.

Given the medium performance of the microcontrollers required to operate an MQTT server in terms of hardware such as CPU, each computing unit can be preloaded with MQTT to be ready for the worst case scenario if the central server provider fails which then passes the lead to the neighbor raspberry device. It is possible due to that high speed and low memory usage of installing the Mosquitto broker to each raspberry PI. This creates a decentralized network system that is robust to manage the system.

In some embodiments, the disaster reconfiguration strategy described above demonstrates the robustness of the grid network with implemented healing algorithms in a square grid. Each tile has four first neighbors and eight second neighbors. However, on a two-dimensional surface, another tiling shape would be a hexagon. In some embodiments, the lunar base is lined with hexagonal tiles instead of square tiles, so each tile will have six first neighbors and twelve second neighbors. This potentially improves the efficacy of the healing algorithm, and such improvement may be quantified. A hexagonal grid may also be more stable against shearing forces parallel to the forces than a square grid, making it more mechanically robust against moonquakes and routine base operations.

The disclosed system depends on interactions between systems of systems. The tile network sits at the top of the systems' hierarchy, which consists of numerous tile units. Each tile unit connects with the external units: smart sensor units and robot control units. Without the tile units, the sensors and robot units do not exist on the base. It is important to monitor how, where, and by whom the operations are executed on the lunar base to avoid conflicts between the robots and other systems. To address this, an example scenario follows where there is a problem with the duct fan in one of the pressurized chambers.

In this example scenario, the duct fans usually maintain the CO₂ level inside the chambers. First, the smart sensors linked to the duct fan report the issue to its home (designated) tile. If the problem is not serious, the tile does not act immediately to the situation as it would report and wait for the human inputs to act. However, if there is an accumulation of CO₂ more than admissible in the chamber, the smart life sensors unit alerts its home tile unit. The tile unit quickly reacts to the situation, announcing it as a hazardous zone for humans. Then, it assigns tasks to one robot that is parked or on duty near the scene, depending on the situation level. Once the robot arrives at the scene, it checks the duct fan's status and sends the report back to the tile unit. After assessing the duct fan's status, the tile unit loads the algorithms on the robot to repair/replace the duct fan. If the duct fan should be replaceable, then the tile requests the smart asset management sensor unit connected to it to get the information about the available duct fan to replace the damaged one. After that, the tile assigns tasks the same robot or to the other robot near to scene to get the duct fan from the storage room. Once the robot completes its tasks, it again sends the data back about the status of the duct fan to the tile. After checking data from the robots and the smart life support system, if everything is normal, the tile reassigns the original tasks to the robots and declares the zone as a habitable zone. In the above scenario, the smart life support sensors units, the tile responsible for monitoring the duct fan, and the robots are in active mode and specifically allotted for the tasks. The operations on the base and overall system are not affected by these repairing tasks, and they operate normally.

Given the complexity of a pioneer lunar surface base, each module may house different equipment and resources. Over time, there is a small chance that an emergency will occur. Examples an emergency are fire breakout, hazardous chemical leak or chemical spillover, or a malfunctioning critical module. For an enclosed space on a lunar surface, having a robust emergency response routine will ensure the survival of the astronaut crew and improve the longevity of the lunar base.

All astronauts will undergo strenuous training before they arrive on the lunar base, and all of them will likely be in their optimal physical and mental state. However, none of them can survive without an EVA suit in the vacuum or in toxic gas for more than several minutes, let alone resolve a hazardous emergency. Automatic internal robots can respond efficiently to emergencies even under conditions considered fatal to astronauts. The robots can also coordinate better than the humans with faster response time and without lapse of logic.

A spreading fire emergency is one illustrative example. A fire model is used to simulate a response to a fire in the lunar base. The fire model has been simplified to reduce the computing load. In the simulation, the burning material catches fire after it reaches the ignition temperature, and the heat release rate increases and releases the heat when time increases. The Heat Release Rate (HRR) profile has been divided into three phases: growth, steady, and decay. The HRR profile varies with the type of fuel.

It is important to evaluate the flammability level of materials on the lunar base for the astronauts' safety and to help model their behavior during the fire. Most materials inside the lunar base are sent from Earth, and once the base develops, the materials will be brought from outside the lunar base from mining or science exploration operations. Once the flammability of the materials is determined, a flammability map of the lunar base can be made to analyze areas on the lunar base sensitive to catching fire. This will help determine the robots' parking location and the location of the fire extinguisher kits inside the base. As mentioned, the robots must be agile to handle the fire situation as most of the materials' HRR profile ends within 500 seconds, meaning it consumes all the burning material within 500 seconds. Thus, robots should be located and reach ground zero before the end of the growth phase once the smart sensor units detect fire. The growth phase is usually around 100 seconds for general household materials, except metals since their slow growth phase takes 10-30 minutes to reach the peak heat release rate. To analyze the flammability, the lunar base map is divided into several regions to understand what materials can be stored in a particular part of the base.

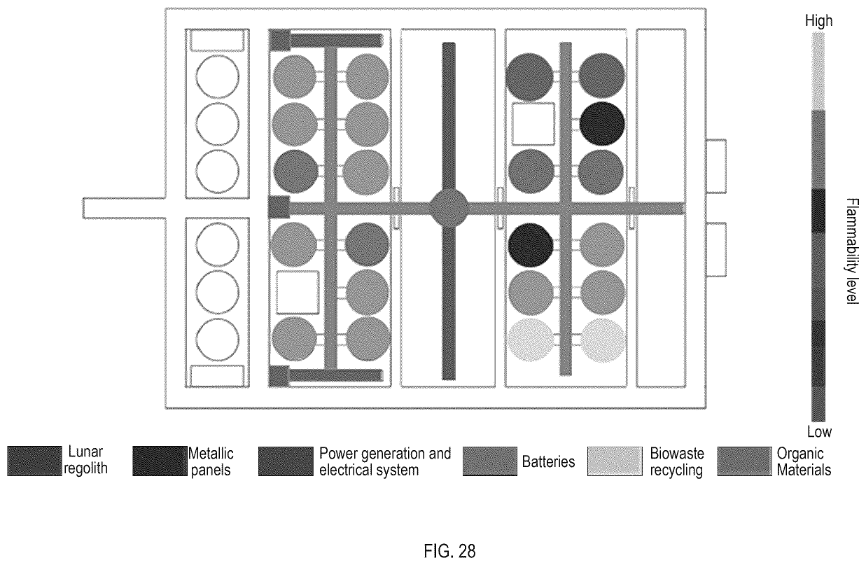

The different types of materials may be, but are not limited to, lunar regolith, metallic panels, materials for power generation and electrical system (electric cables), batteries, bio waste, and organic materials are placed inside the lunar base, and their flammability level is assumed based on Earth conditions. Even though it is not a good approximation as the fire and flammability might differ in the low gravity conditions. However, the current knowledge about fire in reduced gravity conditions makes it difficult to assess the materials' behavior under fire inside the lunar base. Once the flammability level of the materials is analyzed and stored inside the lunar base, the flammability level of a region is determined by taking the average flammability of all the materials in the region. For instance, the kitchen area is usually filled with organic materials, so the flammability level of the kitchen is determined by the average of all organic materials' flammability levels inside the kitchen. A sample flammability map of the lunar base is shown in FIG. 28. The flammability map of FIG. 28 is only shown for the pressurized region as the chance of getting fire without air is low. The smart asset tracking sensors will frequently update this map by accommodating new supplies from Earth and materials from science and mining operations outside the base. In addition, the map is updated whenever large quantities of materials are transported from one place to another inside the lunar base.

Simulations are carried out to evaluate the response of a team of small robots in handling emergency situations. A fire is simulated inside the kitchen. Five different materials with different HRR profiles are assumed inside the kitchen area. The values for the fire model are taken as general household materials. Once the sensors detect the fire, it is communicated to the tile network. The tile network then confirms the fire by validating the sensor data and assigning tasks to a single robot to evaluate and extinguish the fire. Once the single robot fights the fire, it will request assistance if needed, as shown in FIG. 16. Simulations were conducted for the cases including a single robot extinguished the fire alone, and two, three, and up to five robots worked in a team to extinguish the fire to analyze the first response and overwhelming response to the fire.

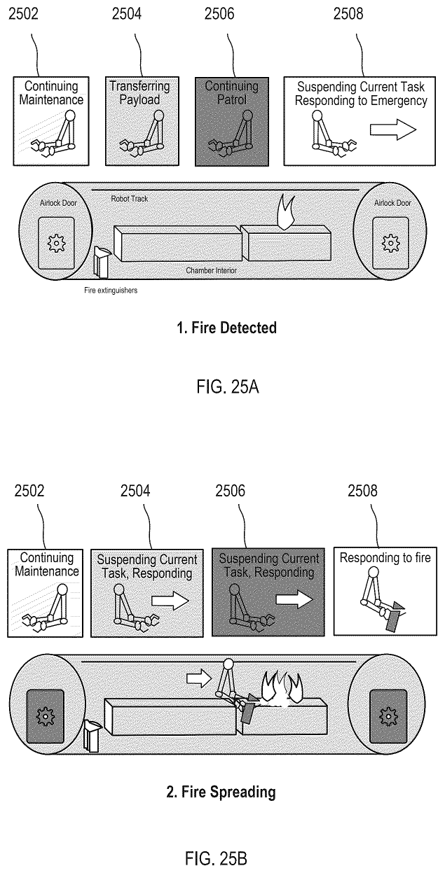

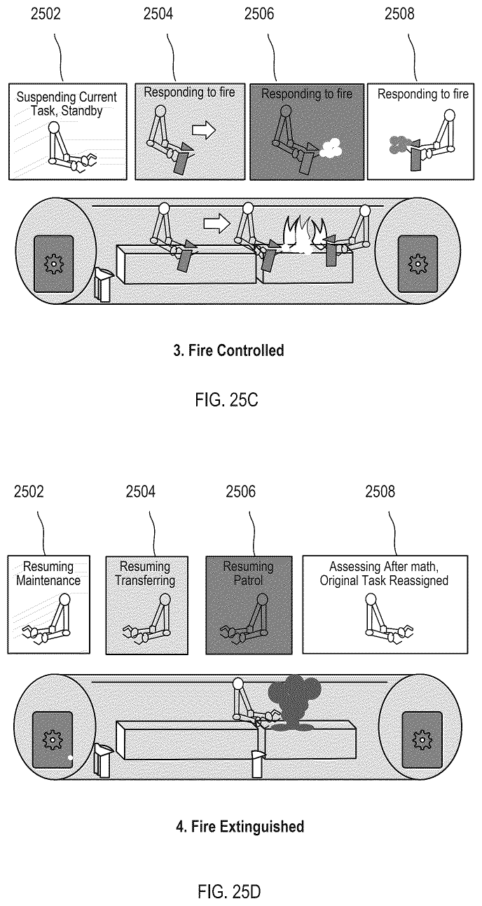

The spreading fire emergency is illustrated in FIGS. 25A-25D . In the example of FIGS. 25A-25D, at first only the closest robot 2508 will suspend its task and move to the scene (FIG. 25A). The remaining robots, robot 2502, robot 2504, and robot 2506 remain on the previously assigned task. As the first robot is fighting the fire, it will also assess the situation and summon more robot companions for assistance. In FIG. 25B, robot 2504 and robot 2506 have suspended their current tasks and are responding to the fire. The summon priority can be determined by the importance of their current tasks as well as their proximity to the scene. In FIG. 25C, robot 2502 has also suspended its current tasks and is responding to the fire.

After fire is controlled in FIG. 25D, all the assisting robots, i.e., robot 2502, robot 2504, and robot 2506, return to their original tasks while the first responding robot 2508 remains to assess the aftermath. The suspended task of the first robot 2508 is reassigned.

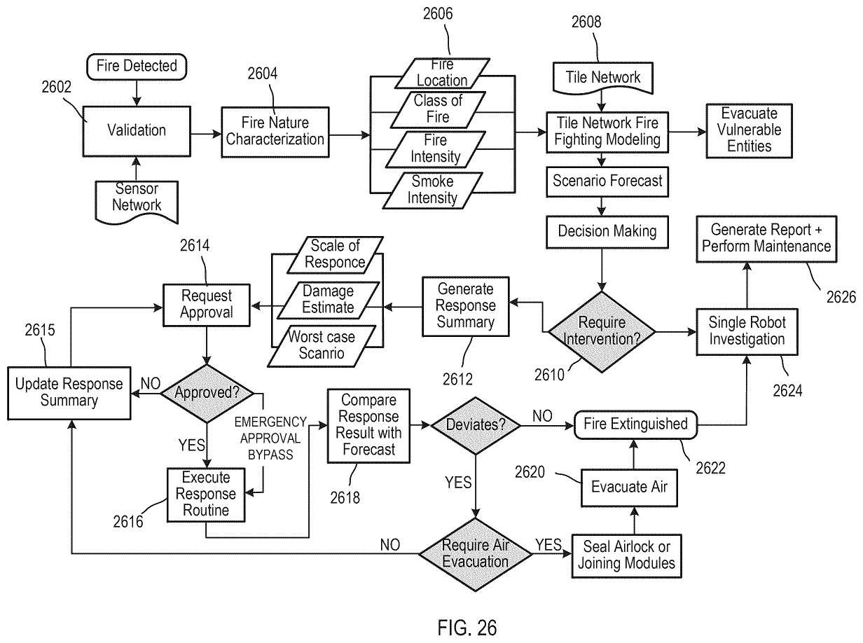

A more detailed fire emergency response routine is shown in FIG. 26. The sensor network permeating the pressurized region provides first-hand detection and validation 2602 of the fire occurrence and location. The sensors in the vicinity correlates data to characterize the nature 2604 of the fire. The characteristics 2606 of the fire are sent to the tile network 2608. With constant stream of data collected by sensors not yet damaged by the fire, the tile network determines whether the fire requires intervention in 2610. If the tile network determines that the fire does require intervention, then the tile network is able to develop a fire spreading model and fighting strategy 2612, which will be communicated to the first responding robot. The response scenario is submitted for approval in 2614, although an emergency approval bypass is available to allow for a response if, for example, the lunar base is unoccupied, or if the inhabitants are incapacitated and unable to respond. The tile network will also provide forecasts and decision recommendation from its models. If the response strategy is not approved by the authorities, the response strategy is updated in 2615 and re-submitted for approval in 2614.

If the response strategy is approved by the authorities, the response routine is executed in 2616, and the base utilizes all necessary resource to fight the fire while minimizing the damage to critical properties and infrastructure. The sensors also provide data to the tile network for examining the difference between prediction and reality in 2618. As a last-ditch effort, if possible, only the affected module will evacuate all the atmosphere in 2620 through proper channels, after sealing any airlocks or adjoining modules, thereby suffocating the fire. Once the fire is extinguished in 2622, the aftermath can then be assessed 2624 by robots for a more comprehensive report 2626.

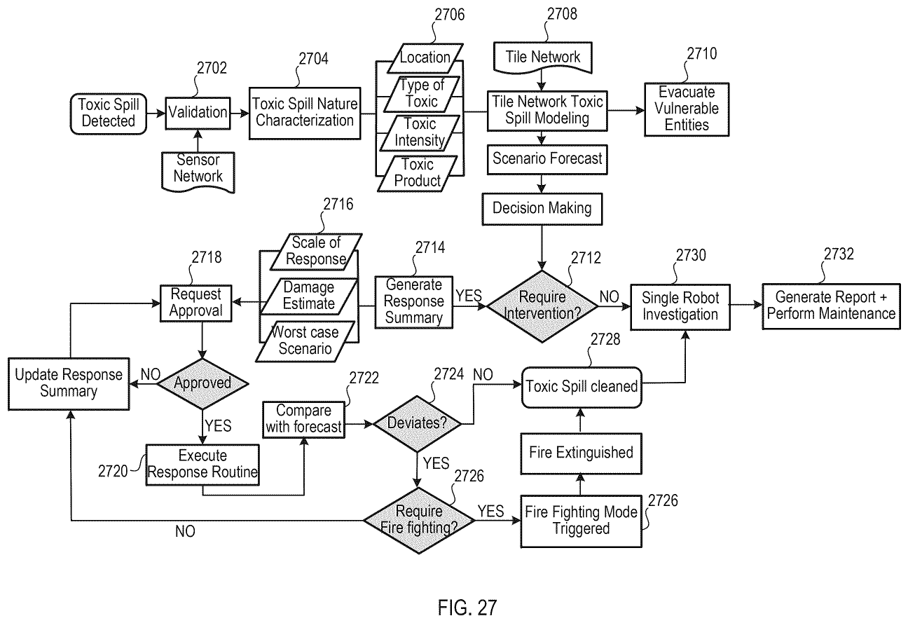

FIG. 27 is an illustrative example of a flow diagram for one possible chemical spillover response, consistent with the present disclosure. The sensor network permeating the pressurized region provides first-hand detection and validation 2702 of the toxic spill occurrence and location. The sensors in the vicinity correlates data to characterize the nature 2704 of the toxic spill. The characteristics 2706 of the toxic spill are sent to the tile network 2708. The tile network 2708 evaluates whether to evacuate vulnerable entities 2710 based on the characterization of the toxic spill and the tile network toxic spill modelling.

With constant stream of data collected by sensors, the tile network 2708 determines whether the toxic spill requires intervention in 2712. If the tile network 2708 determines that the toxic spill does require intervention, then the tile network 2708 is able to generate a toxic spill response summary 2714, which includes characteristics 2716 which may include, but are not limited to, a scale of the response required, a damage estimate, and a worst case scenario. The response scenario is submitted for approval in 2716. Once the response strategy is approved by the authorities, the response routine is executed in 2720. The sensors also provide data to the tile network 2708 compare the prediction to the reality in 2722. If the tile network 2708 determines there is a deviation between the prediction and the reality, then the tile network 2708 determines if a fire fighting response is required. If the tile network 2708 determines that a fire response is required, then the tile network 2708 triggers fire fighting mode (see FIG. 26). If the tile network 2708 determines there is not a deviation between the prediction and the reality, then the tile network 2708 determines that the toxic spill is cleaned in 2728. Once the toxic spill is cleaned in 2728, or the tile network determines in 2712 that the toxic spill does not require intervention, the aftermath can then be assessed 2730 by robots for a more comprehensive report 2732.

The disclosed system provides a rudimentary yet comprehensive design of an early lunar base that houses astronauts, including the systems architecture and the GNC of a team of robots and smart sensor units intended to maintain and operate a lunar surface base. In order to improve the robustness of the base and increase the success rate of base deployment and sustainability, the system adopts a server-like distributed network framework as electronics-embedded computation tiles. These computation tiles communicates with their nearby neighboring tiles to transmit, process, and store information directly and without a central command. The tile networks form zones differentiated by zone functionality, while tiles between zones are also connected with little differentiation. One of which is pressurized regions for astronauts to live and work safely for an extended amount of time. The system provides a baseline interior design inspired by previous works and professional guidelines. The zones form a unit of base that are self-sustaining and carries out scientific and discovery operations.

Also disclosed are the macroscopic functionalities that are enabled by these distributed networks. These functionalities may facilitate the routine base operations automatically, offloading the astronauts' workload, reducing the base power consumption, improving base safety and robustness overall. With disaster reconfiguration/healing algorithms implemented within the tiles (each tile overloads and substitute the lost processing power), the grid is able to sustain nominal processing power even if a number of tiles are damaged. Both solar flare radiation events as well as fire spreading events were simulated as grid damage profiles. It should be noted that grid nominal operation is indeed sustained under significant damage.

In addition, disclosed are first-order robot operation procedures and infrastructure designs to support the design process. In the disclosed system, teams of robots concurrently tackle mundane, dirty, yet necessary tasks that allow the lunar base to persist even under evolving disaster scenarios and work towards active cooperation with the astronauts while maintaining a healthy distance.

According to one aspect of the disclosure there is thus provided a system for distributed computer processing networks for lunar bases and space stations, the system including one or more sensors; a communications network; and a plurality of tiles. The tiles are configured to: monitor the one or more sensors via the communications network; track a location of each computing device using the communications network; and responsive to determining any tile of the plurality of tiles has failed, transfer one or more tasks from the tile that has failed to a neighboring tile.

According to another aspect of the disclosure, there is thus provided a system for distributed computer processing networks for lunar bases and space stations, the system including one or more pressurized cylinders; an asset management unit; one or more robots, each of the one or more robots having an internal control unit; a traffic management system; a smart lighting system; a communications network; a plurality of smart sensors, including environmental sensors; and a plurality of tiles. The tiles are configured to: monitor the plurality of smart sensors; control the smart lighting system based on the plurality of smart sensors; track a location of each computing device using the traffic management system; monitor the environmental sensors; and responsive to determining an emergency exists, direct any of the one or more robots to respond to the emergency.

According to yet another aspect of the disclosure, there is thus provided a system for distributed computer processing networks and integrated robotics for lunar bases and space stations, the system including: one or more sensors; one or more robots; a communications network; and a plurality of tiles, the tiles configured to: monitor the one or more sensors via the communications network; responsive to determining that a fire has been detected by any of the one or more sensors: characterize a nature of the fire; generate a response summary; direct at least one of the one or more robots to respond to the fire; and responsive to determining that assistance is required, directing one or more additional robots to respond to the fire.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

“Circuitry,” as used in any embodiment herein, may comprise, for example, singly or in any combination, hardwired circuitry, programmable circuitry such as processors comprising one or more individual instruction processing cores, state machine circuitry, and/or firmware that stores instructions executed by programmable circuitry and/or future computing circuitry including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), application-specific integrated circuit (ASIC), programmable logic devices (PLD), digital signal processors (DSP), field programmable gate array (FPGA), logic gates, registers, semiconductor device, chips, microchips, chip sets, etc.

Embodiments of the methods described herein may be implemented using a controller, processor and/or other programmable device. To that end, the methods described herein may be implemented on a tangible, non-transitory computer readable medium having instructions stored thereon that when executed by one or more processors perform the methods.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto.

It will be appreciated by those skilled in the art that any block diagrams herein represent conceptual views of illustrative circuitry embodying the principles of the disclosure. Similarly, it will be appreciated that any block diagrams, flow charts, flow diagrams, state transition diagrams, pseudocode, and the like represent various processes which may be substantially represented in computer readable medium and so executed by a computer or processor, whether or not such computer or processor is explicitly shown. Software modules, or simply modules which are implied to be software, may be represented herein as any combination of flowchart elements or other elements indicating performance of process steps and/or textual description. Such modules may be executed by hardware that is expressly or implicitly shown.

The functions of the various elements shown in the figures, including any functional blocks labeled as a controller or processor, may be provided through the use of dedicated hardware as well as hardware capable of executing software in association with appropriate software. The functions may be provided by a single dedicated processor, by a single shared processor, or by a plurality of individual processors, some of which may be shared. Moreover, explicit use of the term controller or processor should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

The term “coupled” as used herein refers to any connection, coupling, link, or the like by which signals carried by one system element are imparted to the “coupled” element. Such “coupled” devices, or signals and devices, are not necessarily directly connected to one another and may be separated by intermediate components or devices that may manipulate or modify such signals.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems. Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

Although the methods and systems have been described relative to a specific embodiment thereof, they are not so limited. Obviously, many modifications and variations may become apparent in light of the above teachings. Many additional changes in the details, materials, and arrangement of parts, herein described and illustrated, may be made by those skilled in the art.

What is claimed is:

1. A system for distributed computer processing networks for lunar bases and space stations, the system comprising:
one or more sensors;
a communications network; and
a plurality of tiles, the tiles configured to:
monitor the one or more sensors via the communications network;
track a location of each computing device using the communications network; and
responsive to determining any tile of the plurality of tiles has failed, transfer one or more tasks from the tile that has failed to a neighboring tile.

2. The system of claim 1, wherein each tile of the plurality of tiles comprises:
one or more computer processors, wherein:
the one or more computer processors are coupled to each other; and
the one or more computer processors form a monolithic, centralized unit as seen by neighboring tiles.

3. The system of claim 1, wherein the communications network uses ultra-wideband (UWB) wireless communications.

4. The system of claim 1, wherein the communications network uses wired communications.

5. The system of claim 4, wherein the plurality of tiles is constructed of durable materials and radiation shielding.

6. The system of claim 4, wherein one tile of the plurality of tiles is arbitrarily assigned as a tile leader.

7. The system of claim 6, wherein the one or more tasks to be processed are delegated among the plurality of tiles by the tile leader.

8. The system of claim 6, wherein the tile leader is reassigned if necessary.

9. A system for distributed computer processing networks for lunar bases and space stations, the system comprising:
one or more pressurized cylinders;
an asset management unit;
one or more robots, each of the one or more robots having an internal control unit;
a traffic management system;
a smart lighting system;
a communications network;
a plurality of smart sensors, including environmental sensors; and
a plurality of tiles, the tiles configured to:
monitor the plurality of smart sensors;
control the smart lighting system based on the plurality of smart sensors;
track a location of each computing device using the traffic management system;
monitor the environmental sensors; and
responsive to determining an emergency exists, direct any of the one or more robots to respond to the emergency.

10. The system of claim 9, wherein each tile of the plurality of tiles further comprises:
one or more single board computers (SBC), wherein each SBC comprises:
one or more computer processors;
one or more sensors;
one or more actuators; and
a network interface to connect to the communications network.

11. The system of claim 9, further comprising:
a plurality of tags, wherein:
each tag of the plurality of tags is attached to a system that is mobile and needs to be located, and
a location of each tag of the plurality of tags is monitored and stored.

12. The system of claim 9, wherein each of the one or more robots further comprises:
a robotic arm;
a payload box;
a light detection and ranging (LIDAR) module camera; and
one or more onboard computer batteries.

13. The system of claim 9, wherein the one or more robots travel through the one or more pressurized cylinders using a rail network.

14. The system of claim 13, wherein the rail network is a ceiling rail network.

15. The system of claim 9, wherein the one or more robots operate autonomously.

16. The system of claim 15, wherein the one or more robots may be controlled by any tile of the plurality of tiles.

17. A system for distributed computer processing networks and integrated robotics for lunar bases and space stations, the system comprising:
one or more sensors;
one or more robots;
a communications network; and
a plurality of tiles, the tiles configured to:
monitor the one or more sensors via the communications network;
responsive to determining that a fire has been detected by any of the one or more sensors:
characterize a nature of the fire;
generate a response summary;
direct at least one of the one or more robots to respond to the fire; and
responsive to determining that assistance is required, directing one or more additional robots to respond to the fire.

18. The system of claim 17, wherein the nature of the fire includes at least one of a location of the fire, a class of the fire, an intensity of the fire, and an intensity of smoke from the fire.

19. The system of claim 17, wherein the response summary includes at least one of a scale of response to the fire, a damage estimate, and a worst case scenario.

20. The system of claim 18, wherein responsive to determining that assistance is required, directing the one or more additional robots to respond to the fire further comprises:
responsive to determining that the fire is not extinguished:
sealing any airlock in the location of the fire;
sealing any adjoining modules in the location of the fire; and
evacuating air from the location of the fire to suffocate the fire.
